(19) United States
(12) Patent Application Publication
(10) Pub. No.: US 2013/0345958 A1
(43) Pub. Date: Dec. 26, 2013

(54) Computing Recommendations for Stopping During a Trip

(71) Applicants: Timothy S. Paek, Sammamish, WA (US); Paramvir Bahl, Bellevue, WA (US)

(72) Inventors: Timothy S. Paek, Sammamish, WA (US); Paramvir Bahl, Bellevue, WA (US)

(73) Assignee: MICROSOFT CORPORATION, Redmond, WA (US)

(21) Appl. No.: 13/533,163

(22) Filed: Jun. 26, 2012

(51) Int. Cl. G01C 21/00

(52) U.S. Cl. 701/400

(57) ABSTRACT

Described is a technology by which context data such as time, location and user-specific data is used to generate a stop recommendation during a vehicle trip. When a user is at a location or travels along a route, one or more stop recommendations may be computed for providing to the user. A cloud service may compute the stop recommendations, and send them to an automotive device of the user, which may be a smartphone coupled to the vehicle, for output to the user.

### BACKGROUND

When a driver is on a trip or is planning a trip, the driver may get directions and/or turn-by-turn navigation from a navigation-capable device. Some devices are able to show a driver where bad traffic is occurring, whereby the driver can request a new route.

A driver may also manually interact with a device to determine what types of businesses or other points of interest are nearby the user, e.g., within a geographic radius of the user. For example, a driver can search to look up gas stations, which may be returned in a results list or the like sorted based upon distance from the user's current location. Such results are distance-based (“geo-fenced”) relative to the user's current location, and need considerable manual interaction on the part of the user.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a recommendation set comprising one or more stop recommendations is computed based upon context data. In one aspect, the context data includes information corresponding to time, information corresponding to points of interest, and information corresponding to user-specific data, such as a current location of a user's vehicle. At least one stop recommendation in the recommendation set is output, e.g., for receipt by an automotive device of the vehicle.

In one aspect, a recommendation engine is configured to process context data to output a stop recommendation associated with a vehicle trip, in which the context data includes location data and user-specific data. The recommendation engine may be implemented in a cloud service. An automotive device may receive the stop recommendation, and provide a corresponding output to a user in the vehicle. Example other context data may include user preference data, vehicle state data, crowd source data, traffic data, event data, task data and/or calendar data.

In one aspect, there is described processing context data as a vehicle travels over a route, in which the context data includes current location data relative to the route. Also described is determining a stop recommendation set comprising at least one stop recommendation at a future location along the route, and sending data corresponding to at least one stop recommendation of the recommendation set to an automotive device of the vehicle for output.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a representation of an example automotive device coupled to information sources so as to output stop recommendations, according to one example embodiment.

FIG. 2 is a block diagram of example components and data used in computing and outputting stop recommendations, according to one example embodiment.

FIG. 3 is a flow diagram representing example steps that may be taken to make and/or modify a stop recommendation, according to one example embodiment.

FIG. 4 is a block diagram representing an example computing environment, in the form of a mobile computing device, into which aspects of the subject matter described herein may be incorporated.

### DETAILED DESCRIPTION

Various aspects of the technology described herein are generally directed towards using context data, such as shallow context data including time-of-day and location (e.g., based upon GPS, triangulation and/or route prediction), or deep context data including information processed from car state data, user preference data, traffic data, calendar data, event data, location data and/or crowd-sourcing provide data to offer intelligent choices for trip planning, including recommending stops (including similar diversions, even if not actually stops) on the route. In one implementation, some or all of the various context data is processed by a cloud service to provide the recommendations.

It should be understood that any of the examples herein are non-limiting. For one, while a mobile device is used as an example of a suitable device for implementing the technology described herein, a more stationary (e.g., built-in or partially built-in) device may be used with a vehicle. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computer-related user interaction and navigation in general.

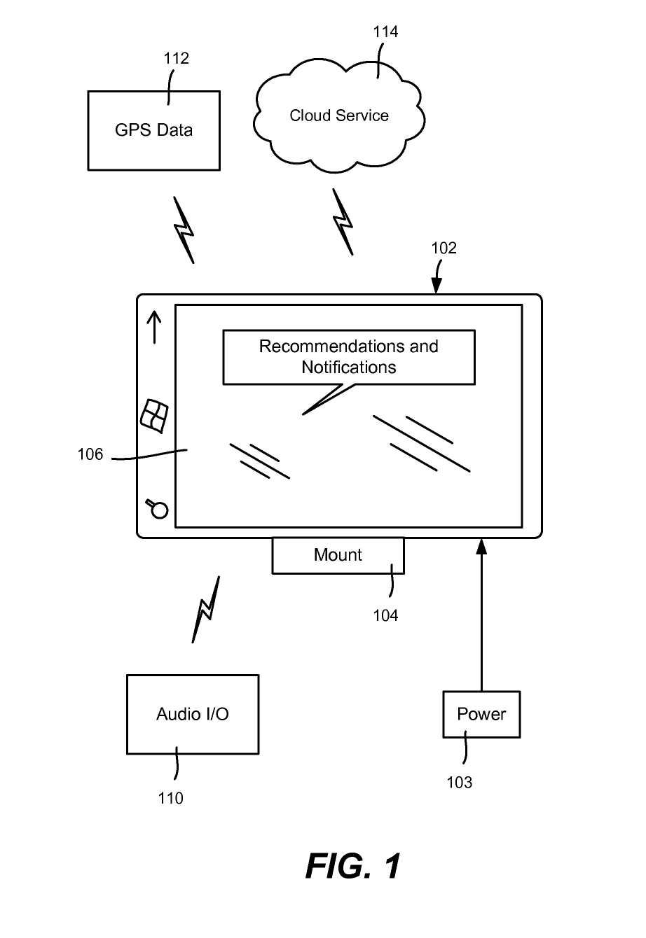

FIG. 1 shows a block diagram comprising an example implementation in which a mobile device 102 such as a user's cellular phone is coupled to a vehicle dashboard via a suitable mount 104. The mount 104 may include an interface such that when mounted, the device 102 receives power 103 and may be coupled to other input and/or output mechanisms. Alternatively, a separate interface such as a physical connector (e.g., to the device's USB interface) may be used for power and/or other input/output.

In the example implementation of FIG. 1, an automotive user interface 106 by which input is received and output is rendered comprises the touch-sensitive display screen of the device 102. However, as can be readily appreciated, various alternative implementations may be used to implement the technology described herein. For example, a typical built-in vehicle navigation or entertainment system already provides a display screen and interactive capabilities, whether via a touch-sensitive screen or by controls (e.g., buttons) for navigating a set of menus and the like, and such a system may be coupled to sources of data and programmed to input and output information as described herein. As also described herein, audio I/I 110 such as speech may be used to provide input, audio (e.g., spoken notifications and recommendations) may be output, and so forth. The display may be a heads-up display in another implementation.

As described below, the device also receives GPS data 112, whether directly or from another source. The device is also wirelessly coupled to a cloud service 114.

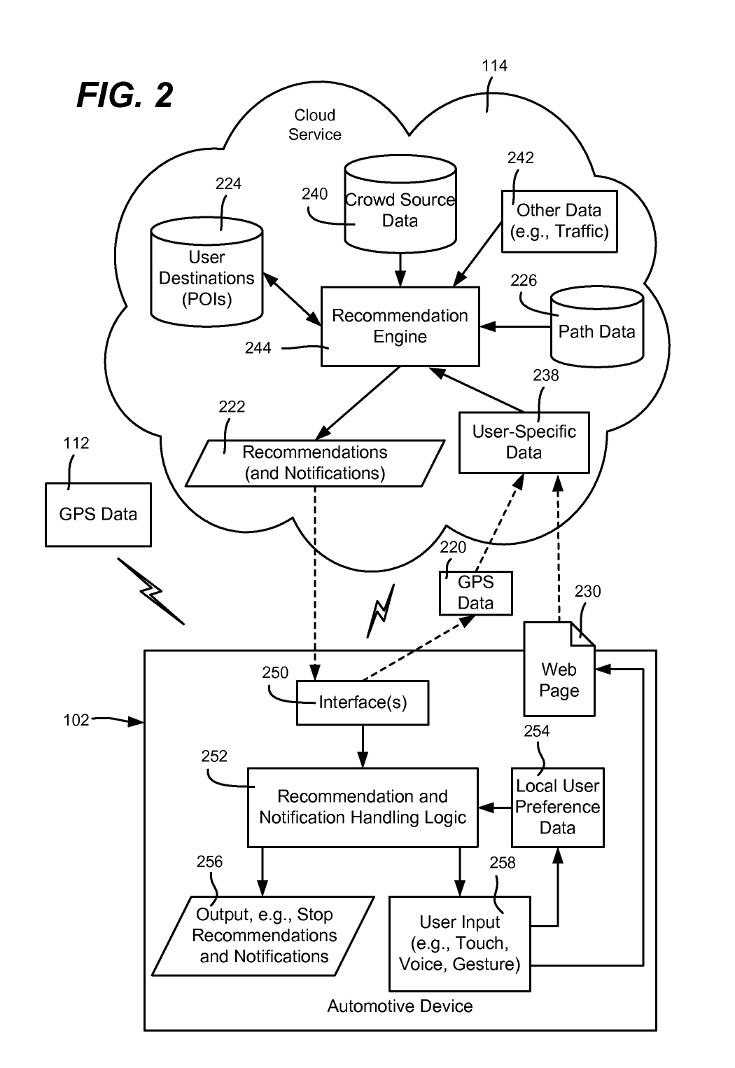

FIG. 2 is a block diagram representing example components of one embodiment. In FIG. 2, in general, the automotive device 102 (which may be the user's smartphone when coupled thereto) relays current GPS data 220 to the cloud service 114 and receives stopping recommendations 222 (and possibly other notifications) therefrom. As will be understood, the recommendations 222 are generally route-based, but can be location-based if a route is not known or reasonably predictable, possibly including alternative predicted routes. Example stop recommendations may include rest stops, restaurants/fast food locations, gas stations, scenic diversions, task-related stops (e.g., pick up milk or dry cleaning) and anywhere else that is computed as a likely desirable stop for a given user. A task may be marked as urgent (“pick up prescription”) or lower priority, which may factor into the recommendation engine's computations.

In general, the stop recommendations are made by a recommendation engine based upon various input data, including context data. Input data may include past user destinations 224 (points of interest, or POIs) for the user as well as other users. A point of interest for a user may include metadata such as time arrived and time departed, whether others were there (e.g., family) and so on. Path data 226 may include maps or the like that provide possible user routes and locations such as businesses or other stopping points along the routes. Context data may include one or more preferences learned from points of interest, accessibility of location on a route, minimization of route distance, and/or other properties of the route and stop.

Other input data may include user specific data 228, including the GPS data 220 and any user provided data, e.g., via previous interaction with a web page 230 or the like that is uploaded to the service 114, possibly via a different device. User calendar and/or task data, car-related state data (e.g., oil, temperature, tire pressure, amount of gas in the tank and so forth, number of passengers in the car and so forth), user preference data, user-specific event data and so forth are other examples of user-specific data 238 of which the cloud service may be made aware. Note that other devices and/or other users may provide such user-specific data 238 to the cloud service 114. For example, the user's calendar may be on a home personal computer, a spouse may add a task (“pick up dry cleaning”) to a shared task location, and so forth.

Thus, in one aspect, users (and potentially one or more designated others such as family members) may add items to a “To Buy” list in the cloud. The recommendation engine may then present recommendations/notifications for the user to buy those items when out. For example, audio output may ask the user something like (e.g., “a grocery store is one mile away and you need to buy milk, would you like directions?”). Not only may the route be considered, but geo-fenced reminders become more useful, not only because power is always on, but also because users have the ability to easily buy what is listed, including without having to search.

With respect to user preference data, virtually any information the user wants to share with the service may be used, some of it already logged/residing on various user devices. For example, purchasing history, places the user has visited in the past, places the user has contacted, user preferences for specific domains such as music, audio books, points of interest for tourism and so forth are all useful inputs. A user may volunteer additional information, e.g., via interaction with a web page 230 or the like, such as to list likes and dislikes not necessarily otherwise obtainable from a user device.

Crowd source data 240 is another type of data that the cloud may maintain and/or access, and may include reviews, previous stops by other users, traffic gleaned from other user's GPS data, and user profiles (such as clustered for collaborative filtering as described below). Other data 242 that may be available to the cloud service 114 may include traffic data (from a non-crowd source such as a regional transportation department website), downloadable coupons, current prices and offers, current events such as an open drawbridge, and so forth.

In general, the various data are input into a recommendation engine 244 of the cloud service 114 to obtain a recommendation for the user at appropriate times. Time of day (not shown) is another factor, e.g., there is no reason to recommend a store that closes at 8:00 pm when it is midnight. Calendar data may be used, e.g., a user who is traveling to a meeting and will be just one time or late may not get a recommendation to stop for coffee.

Note that unlike simple distance-based searches, recommendations from the recommendation engine 244 may be intelligent in nature and computed based upon a (possibly large) set of context data, which may include a known destination, or a predicted destination based upon user patterns and/or prior destinations. For example, if the engine knows that a user is traveling to Vancouver, Canada leaving (or having departed from) Seattle, Wash. at 10 am, then the recommendation engine 244 can recommend a restaurant that's approximately two hours away, which is when most people eat lunch. The recommended restaurant may be based on a user's cuisine preferences or likely preferences, learned from prior stops, the user's profile compared to other users, or explicit information from the user. Thus, instead of recommending a stop for lunch at a location at which the user is due to arrive at 12:00 pm, the recommendation may be for 12:30 pm at a restaurant that is likely more suited to the user's taste. Alternatively, if gas is running low, based upon car state data and location awareness the recommendation may be a restaurant near a gas station. Running low on gas may be predicted rather than actual, e.g., based upon the mileage a user's car typically gets, where the user is likely to be on the route when gas will be running low, and what the gas prices are in that general location versus others (there may be a significant price difference when crossing a state or county line, for example).

Recommendations may offer “stretch breaks” approximately every N hours for long trips, at convenient stops, and/or at places that offer a scenic view. This also may be based on time of day, as scenic may not apply at 8 pm at night, while secluded rest stops may be considered relatively dangerous after 10 pm. Traffic or expected traffic also may be used to make a recommendation, e.g., if a user's predicted route is through a busy city at the peak of rush hour, a recommendation to stop at a rest stop before reaching the city limits rather than after the city limits may be made.

For deciding what points of interest to show users in a tourist-centric scenario, the user's social network may be accessed, and/or the points of interest on the user's route obtained from other users who are similar to the user in some way. To this end, similarity can be computed in terms of collaborative filtering, clustering, and the like. In this way, users can go to where their friends and/or users with similar profiles have gone. Any of various well-known techniques for taking advantage of such user models may be adapted with respect to stop recommendations as described herein.

Machine learning or the like may be used to develop and maintain user-specific models, whether for individual users and/or profiles of users, such as based on type. For example, via collaborative filtering/clustering technology, the recommendation engine 244 may learn that users who shop at a particular clothing store X also tend to prefer a grocery store Y that specializes in organic foods. Thus, the recommendation engine 244 may weigh this observed relationship in deciding whether to make a recommendation to a user or not. Features may be extracted from the various data and used to train a feature-based classifier, for example, which then inputs user-related features when a recommendation determination needs to be made.

As shown in FIG. 2, one or more recommendations are received at a suitable interface 250 on the automotive device 102. Recommendation (and notification) handling logic 252 may process the recommendations and determine whether and when to output them, possibly in conjunction with local user preference data 254. For example, a recommendation may be cached by the handling logic 252 for later output, in case communication with the cloud service is not available at the appropriate time for outputting the recommendation. As another example, a user may not want certain preference data uploaded to the cloud, therefore some local preference data 252 may be private data kept on the user's device.

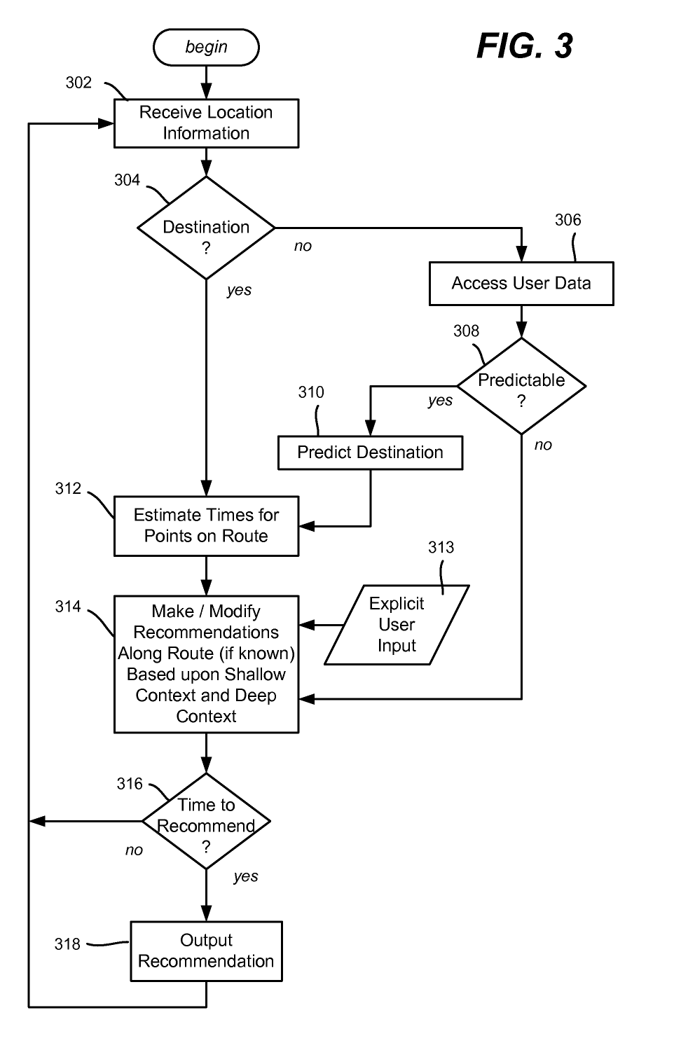

FIG. 3 is an example flow diagram directed towards processing by the cloud of a user's data, beginning at step 302 where the user's current location data is received. This may be sent every few seconds or so, for example, as for a vehicle the power used in such a transmission will not drain the device.

Step 304 tests for whether a destination is known, or at least to a sufficient threshold probability. If not, step 306 accesses user data and determines whether at least a reasonable prediction can be made based upon the available data. For example, a route can be easily predicted from past history, even with very little location data available to plot a likely path, when it is a workday and the user starting out at this time of day virtually always winds up at work. If a route or a sufficient part of a route can be predicted, e.g., to a sufficient level of usefulness (step 308) step 310 predicts the destination. Step 312 represents estimating times for various points on the route, e.g., filtered by user preferences and any other criteria, in which the user may be interested in stopping.

Step 314 represents making or modifying a set of recommendations, which may be current or future recommendations. Note that if a destination is not known or predictable, a recommendation may be able to be made based upon the current location only, e.g., if a user is very low on gas, a nearby gas station on any possible route may be recommended; (thus step 308 may branch to step 314 even without a reasonably predictable route).

As part of step 314, future recommendations may be modified as new data is obtained. For example, a user may divert from a recommended route or not follow a predicted route, and a new recommendation may be computed to adjust for the change.

Step 316 represents waiting until it is time to make at least one recommendation. In this way, future recommendations may be held until appropriate for a user. Step 318 outputs the recommendation or recommendations if time to do so, e.g., via block 256 of FIG. 2 (or possibly via another device, such as Bluetooth®-coupled to the device 102. That is, a recommendation may be timed for output, such as when the user approaches the recommended stop; the time may be updated as needed, such as if the user is delayed. Note that in a caching situation where recommendations are locally cached, steps 316 and 318 may be performed (at least in part) by the vehicle device's logic, with the cloud service updating the cache when possible if the recommendation set needs to be updated.

One other aspect represented in FIG. 3, step 313, is modifying the recommendation set based upon user activity, such as explicit user input. For example, a user may be scheduled to receive a recommendation for lunch at 11:30 am, but at 10:30 the user may speak or otherwise input (block 258, FIG. 2) into the device “I'm hungry” or the like. This input may be used to re-compute one or more recommendations in the set, e.g., create a new one for a restaurant on the route at 10:45 and replace the 11:30 am recommendation in the set, although it may be recomputed if the user does not stop for the 10:45 recommendation. Further, use inactivity may be used, e.g., if recommendations are made but ignored, the recommendation engine 224 may learn based upon the assumption that that bad recommendations or the like were made.

### Example Operating Environment

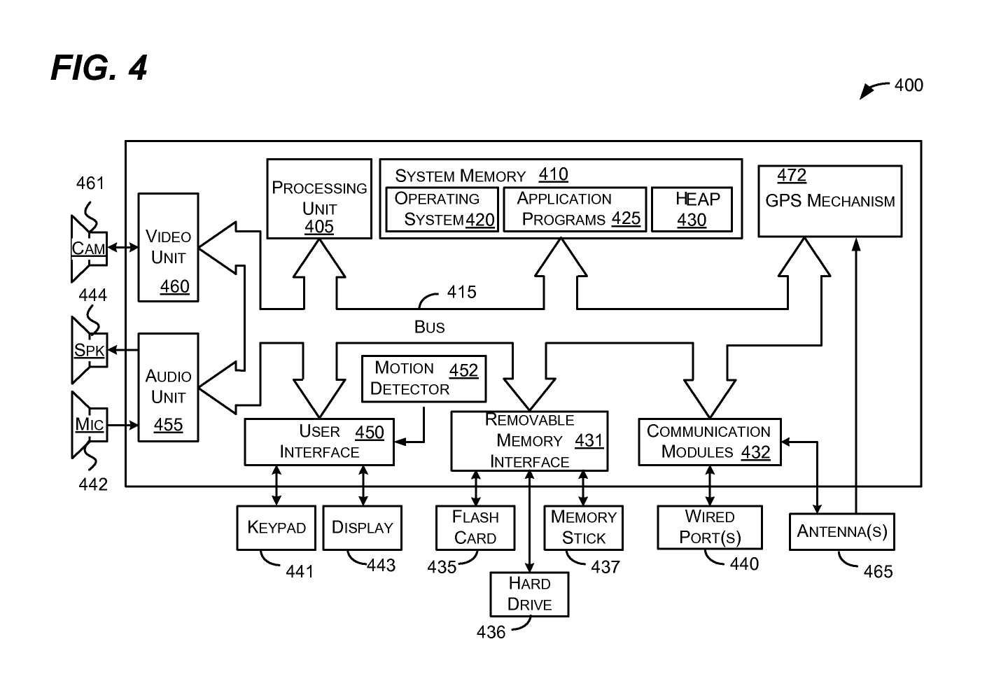

FIG. 4 illustrates an example of a suitable mobile device 400 on which aspects of the subject matter described herein may be implemented. The mobile device 400 is only one example of a device and is not intended to suggest any limitation as to the scope of use or functionality of aspects of the subject matter described herein. Neither should the mobile device 400 be interpreted as having any dependency or requirement relating to any one or combination of components illustrated in the example mobile device 400.

With reference to FIG. 4, an example device for implementing aspects of the subject matter described herein includes a mobile device 400. In some embodiments, the mobile device 400 comprises a cell phone, a handheld device that allows voice communications with others, some other voice communications device, or the like. In these embodiments, the mobile device 400 may be equipped with a camera for taking pictures, although this may not be required in other embodiments. In other embodiments, the mobile device 400 may comprise a personal digital assistant (PDA), hand-held gaming device, notebook computer, printer, appliance including a set-top, media center, or other appliance, other mobile devices, or the like. In yet other embodiments, the mobile device 400 may comprise devices that are generally considered non-mobile such as personal computers, servers, or the like.

Components of the mobile device 400 may include, but are not limited to, a processing unit 405, system memory 410, and a bus 415 that couples various system components including the system memory 410 to the processing unit 405. The bus 415 may include any of several types of bus structures including a memory bus, memory controller, a peripheral bus, and a local bus using any of a variety of bus architectures, and the like. The bus 415 allows data to be transmitted between various components of the mobile device 400.

The mobile device 400 may include a variety of computer-readable media. Computer-readable media can be any available media that can be accessed by the mobile device 400 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 400.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, Wi-Fi, WiMAX, and other wireless media. Combinations of any of the above should also be included within the scope of computer-readable media.

The system memory 410 includes computer storage media in the form of volatile and/or nonvolatile memory and may include read only memory (ROM) and random access memory (RAM). On a mobile device such as a cell phone, operating system code 420 is sometimes included in ROM although, in other embodiments, this is not required. Similarly, application programs 425 are often placed in RAM although again, in other embodiments, application programs may be placed in ROM or in other computer-readable memory. The heap 430 provides memory for state associated with the operating system 420 and the application programs 425. For example, the operating system 420 and application programs 425 may store variables and data structures in the heap 430 during their operations.

The mobile device 400 may also include other removable/non-removable, volatile/nonvolatile memory. By way of example, FIG. 4 illustrates a flash card 435, a hard disk drive 436, and a memory stick 437. The hard disk drive 436 may be miniaturized to fit in a memory slot, for example. The mobile device 400 may interface with these types of non-volatile removable memory via a removable memory interface 431, or may be connected via a universal serial bus (USB), IEEE 4394, one or more of the wired port(s) 440, or antenna(s) 465. In these embodiments, the removable memory devices 435-437 may interface with the mobile device via the communications module(s) 432. In some embodiments, not all of these types of memory may be included on a single mobile device. In other embodiments, one or more of these and other types of removable memory may be included on a single mobile device.

In some embodiments, the hard disk drive 436 may be connected in such a way as to be more permanently attached to the mobile device 400. For example, the hard disk drive 436 may be connected to an interface such as parallel advanced technology attachment (PATA), serial advanced technology attachment (SATA) or otherwise, which may be connected to the bus 415. In such embodiments, removing the hard drive may involve removing a cover of the mobile device 400 and removing screws or other fasteners that connect the hard drive 436 to support structures within the mobile device 400.

The removable memory devices 435-437 and their associated computer storage media, discussed above and illustrated in FIG. 4, provide storage of computer-readable instructions, program modules, data structures, and other data for the mobile device 400. For example, the removable memory device or devices 435-437 may store images taken by the mobile device 400, voice recordings, contact information, programs, data for the programs and so forth.

A user may enter commands and information into the mobile device 400 through input devices such as a key pad 441 and the microphone 442. In some embodiments, the display 443 may be touch-sensitive screen and may allow a user to enter commands and information thereon. The key pad 441 and display 443 may be connected to the processing unit 405 through a user input interface 450 that is coupled to the bus 415, but may also be connected by other interface and bus structures, such as the communications module(s) 432 and wired port(s) 440. Motion detection 452 can be used to determine gestures made with the device 400.

A user may communicate with other users via speaking into the microphone 442 and via text messages that are entered on the key pad 441 or a touch sensitive display 443, for example. The audio unit 455 may provide electrical signals to drive the speaker 444 as well as receive and digitize audio signals received from the microphone 442.

The mobile device 400 may include a video unit 460 that provides signals to drive a camera 461. The video unit 460 may also receive images obtained by the camera 461 and provide these images to the processing unit 405 and/or memory included on the mobile device 400. The images obtained by the camera 461 may comprise video, one or more images that do not form a video, or some combination thereof.

The communication module(s) 432 may provide signals to and receive signals from one or more antenna(s) 465. One of the antenna(s) 465 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 472. In turn, the GPS mechanism 472 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 400 may connect to one or more remote devices. The remote devices may include a personal computer, a server, a router, a network PC, a cell phone, a media playback device, a peer device or other common network node, and typically includes many or all of the elements described above relative to the mobile device 400.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, accessing context data including information corresponding to time, information corresponding to points of interest, and information corresponding to user-specific data, computing a recommendation set comprising one or more stop recommendations based upon the context data, and outputting data that corresponds to at least one stop recommendation in the recommendation set.

2. The method of claim 1 wherein the context data includes path data, and wherein computing the recommendation set comprises processing the path data corresponding to one or more routes and determining a stop recommendation for a location along a route of the one or more routes.

3. The method of claim 1 wherein the context data includes path data, and wherein computing the recommendation set comprises processing the path data corresponding to one or more routes and determining a stop recommendation for an estimated time along a route of the one or more routes.

4. The method of claim 1 wherein the context data includes one or more preferences learned from points of interest, accessibility of location on a route, minimization of route distance, or other properties of the route and stop, or any combination of preferences learned from points of interest, accessibility of location on a route, minimization of route distance, or other properties of the route and stop.

5. The method of claim 1 further comprising, modifying the recommendation set based upon a change to the context data.

6. The method of claim 5 further comprising obtaining traffic data as part of the context data, and wherein modifying the recommendation set based upon a change to the context data comprises using the traffic data.

7. The method of claim 1 further comprising, receiving information corresponding to user activity or inactivity, or both, and modifying the recommendation set based upon the user activity or inactivity, or both.

8. The method of claim 1 wherein the user-specific data comprises location data, and further comprising, receiving updated location data and modifying the recommendation set based upon the updated location data.

9. The method of claim 1 wherein the context data includes crowd source data, and wherein computing the recommendation set comprises processing the crowd source data.

10. The method of claim 9 wherein processing the crowd source data comprises determining profiles for sets of other users, determining a profile for a user corresponding to the user-specific data, matching the profile for the user with a matching profile among the sets of profiles for the other users, and basing a stop recommendation at least in part upon data corresponding to the matching profile.

11. The method of claim 9 wherein processing the crowd source data comprises obtaining a point of interest from a social network contact, and using the point of interest to compute a stop recommendation.

12. A system comprising, at least one processor and memory, the memory including instructions, corresponding to a recommendation engine, that are executed by the processor, the recommendation engine configured to process context data to output a stop recommendation associated with a vehicle trip, in which the context data includes location data and user-specific data.

13. The system of claim 12 wherein the at least one processor and memory are implemented in a cloud service.

14. The system of claim 12 further comprising an automotive device configured to receive the stop recommendation.

15. The system of claim 12 wherein the context data further comprises time data.

16. The system of claim 12 wherein the context data comprises data corresponding to points of interest.

17. The system of claim 12 wherein the context data comprises data corresponding to a route

18. The system of claim 12 wherein the context data comprises user preference data, vehicle state data, crowd source data, traffic data, event data, task data or calendar data, or any combination of user preference data, vehicle state data crowd source data, traffic data, event data, task data or calendar data.

19. One or more computer-readable media having computer-executable instructions, which when executed perform steps, comprising, processing context data as a vehicle travels over a route, in which the context data includes current location data relative to the route, determining a stop recommendation set comprising at least one stop recommendation at a future location along the route, and sending data corresponding to at least one stop recommendation of the recommendation set to an automotive device of the vehicle for output.

20. The one or more computer-readable media of claim 19 having further computer executable instructions comprising receiving updated context data, including updated current location data from the automotive device of the vehicle, and modifying the recommendation set based upon the updated context data.
